(19) United States
(12) Patent Application Publication
(10) Pub. No.: US 2016/0044025 A1
(43) Pub. Date: Feb. 11, 2016

(54) SYSTEM AND METHOD FOR SECURITY ENHANCEMENT

(71) Applicants: Puneet GOYAL, Dehradun (IN); THE REGISTRAR, GRAPHIC ERA UNIVERSITY, Dehradun (IN)

(72) Inventors: Puneet GOYAL, Dehradun (IN); Nitin KHANNA, Dehradun (IN)

(21) Appl. No.: 14/809,746

(22) Filed: Jul. 27, 2015

(30) Foreign Application Priority Data
Aug. 7, 2014 (IN) 2247/DEL/2014

(51) Int. Cl. H04L 29/06

(52) U.S. Cl. CPC H04L 63/0838; H04L 63/1483

(57) ABSTRACT

A system and method thereof for secure authentication using multimedia contents set particular to user (MCSPU) and user specified parameters is disclosed. A host system for performing an authentication with a user system is disclosed. The host system comprises of a processor; and a memory coupled to said processor for executing a plurality of modules present in said memory. For the authentication (while logging in or performing a transaction), the host system would provide to the user one or more elements belonging to MCSPU, after embedding, within the elements the authentication related critical information using the user specific parameters. The proposed method ensures the user that the response is coming from authentic system. In case of suspicious user behavior, the parameters or multimedia contents not specific to the user could be used.

### CROSS-REFERENCE OF THE RELATED APPLICATION

This application claims priority to Indian Patent Application No. 2247/DEL/2014, filed with the Indian Patent Office on Aug. 7, 2014 and entitled “A SYSTEM AND METHOD FOR SECURITY ENHANCEMENT”, which is incorporated herein by reference in its entirety.

### TECHNIAL FIELD

The present subject matter described herein, in general, relates to computer security, and more particularly, to a system and method for verifying an authenticity of network communication and/or transactions within computing environments.

### BACKGROUND

With the advancement of technology, online banking has tremendous impact on the economy all across the world. While it does offer users great convenience and flexibility, there are also several security issues associated with it. The security reports of several agencies like FireEye, RSA, Websense, and even RBI data shows that cyber frauds are hitting economy badly in developed and developing countries worldwide.

Phishing is a continual global threat that aims to trick the user into divulging his/her sensitive information (username, passwords, account details, user credentials, credit/debit card details etc.), by pretending as an authentic/legitimate entity in a network communication. Phishing attempts are generally carried out through email that often include socially-engineered text and links to fake (but authentic looking) website of a provider such as bank, e-commerce site or social networking site. As per RSA, there were around 32,500 phishing attacks per month globally in 2012, totalling a loss of $687 million. As per Symantec Internet Security Threat Report 2014, there was 62% increase in the number of breaches and over 552 million identities were exposed via breaches in 2013. The global average phishing rate has increased from 1 in 414 in 2012 to 1 in 392 in 2013. As per Symantec Intelligence Report 2013, phishing attacks spoofing financial organizations, including banks, accounted for 69 percent of phishing scams in June 2013. Over time, phishing attacks have expanded in the scope of their targets from not only banks, credit unions and other financial institutions, but to a variety of other organizations as well. The number of phishing URLs originating from social media sources increased six-fold in November 2013 as compared to the previous month. Login credentials for accounts seem to be the main information phishers are looking for. One of the solutions used by most of the websites currently requires the user to select during an enrollment process some information (an image, personalized text or phrase, etc.) that is consider secret between the user and the host system. Whenever user attempts to login with his/her user id, the host system displays the user specific information to indicate the user that he/she is accessing the authentic website. But this information can be easily spoofed by fraudster by first collecting the user specified information (images, phrase, etc.) from the authentic host system, and then using this information database to trick the users via phishing attack.

Man-In-The-Browser (MitB) attack is another serious security threat used by the fraudsters for stealing the money/assets in an online transaction. It is a variation of the Man-in-the-Middle (MitM) attack, but more advanced than the MitM attack used by the cybercriminals for session hijacking in an online transaction. In this technique, the attacker resides in the web browser rather than on the network. For example, a MitB may be a malware that may reside either in the user system or in the host system. The MitB may be functionally similar to MitM. MitB uses various proxy Trojans like Zeus for stealing the credentials or URLZone\Bebloh for manipulating the form content sent to the authenticating server. These Trojans are deployed in the form of a configuration file. Browsers can be very easily infected by these Trojans. Once inside these Trojans spy on the browser sessions and become active as soon as they detect some activity on the (financial) sites mentioned in their configuration file. Once activated these Trojan can intercept all the data sent and received between the user and the bank server. All this happens in the background and the user is not aware that his security has been compromised. In MitB attack user is made to believe that the transaction is carried out as he wanted but in reality he has lost the money/assets. Authenticating institute also has no knowledge about the attack. The user is shown the original information what he entered for the transaction but in turn, the attacker/Trojan sends a different information (unknown to the user) to the bank server.

Symantec's State of Financial Trojans 2013 whitepaper concluded that in the first three quarters of 2013, the number of banking Trojans tripled. The most common form of attack continues to be financial Trojans which perform a MitB attack on the client's computer during an online banking session. RSA 2012 Cybercrime Trends Report has ranked Zeus Trojan as the top financial malware. RSA reports that, “Zeus is responsible for around 80% of all attacks against financial institutions today and is estimated to have caused over $1 billion in global losses in the last five years.” Most of the financial institutes consider MitB to be the greatest threat to online banking. MitB attack is invincible to security mechanisms like Secure Socket Layer (SSL), two factor authentications and three factor authentications. Antivirus software have very low detection rate for these Trojans.

Traditionally there are various existing approaches to address MitB; few of them are included here. Hardened Browser on a USB Drive is one of the techniques, which uses a hardware device having a secure browser designed for online banking e.g. eToken NG-Flash. However, this approach has certain limitations like it involves additional cost. Further, it is inconvenient for the end user to carry this all the time and it lacks accessibility to all. Another approach is Live CDs\Virtual Machines, in this approach a boot from a Live CD or on a virtual machine is performed when user wants to do online transactions. However, the approach is not comfortable for the end user to boot differently every time he/she wants to make a transaction and further, it's a time consuming approach. Another approach is Out-of-Band (OOB) Authentication in which Bank sends the One Time Passcodes (OTP) using a different band (e.g. SMS to User registered mobile) for online banking transaction. However, the approach can be compromised by waiting for the user to enter the OTP and then overtaking the transaction. Various methods of authentication based on the CAPTCHA (Completely Automated Public Turing test to tell Computers and Humans Apart) concept have also been proposed in various patent documents. Few of the earlier proposed solutions are summarized below.

The prior-art document U.S. Pat. No. 8,577,811, titled “In Band Transaction Verification”, issued to Adobe Systems Incorporated, discloses a system and method for in-band transaction verification that may include a transaction verification component. The document discloses a method similar to CAPTCHA (Completely Automated Public Turing test to tell Computers and Humans Apart) where transaction details and possibly an OTP can also be included.

The prior-art document US 2007/0083919 A1, titled “Secure Image Protocol”, discloses a method for providing a secure login to a website, wherein a user's authority to enter the website is checked for authenticity. The cited document discloses a secure image protocol that can be used as a substitute or additional security layer during the login process or during high-risk transactions. Bank responds with plurality of images to choose from. The cited document proposes a mechanism that protects against some phishing attacks.

The prior-art document U.S. Pat. No. 8,577,811 titled “Validated mutual authentication”, proposes use of fractal images in authentications. In this method, a user selects a fractal image, from among a plurality of fractal images, during an authentication process. In subsequent transactions, the user is required to select that same fractal image, from among a plurality of fractal images, to authenticate her/him.

The prior-art document U.S. Pat. No. 8,356,333 B2, titled “System and Method for verifying networked sites”, discloses a system and method for indicating to a user that a networked site is authentic that includes a verification application. The verification application has access to encrypted user customized information that was previously selected by the user and used in process of verifying the authenticity of the networked site.

The prior-art document U.S. Pat. No. 7,200,576, entitled “Secure online transactions using a CAPTCHA image as a watermark” generally relates to techniques for conducting secure online transactions using CAPTCHA images as watermarks.

The prior-art document U.S. Pat. No. 7,197,646 entitled “System and method for preventing automated programs in a network” is generally directed at diminishing the use of automated programs in a networked environment. A server provides a client computer with a visual test upon a request transmitted through the network by the client computer to the server. The visual test requires the client computer to perform a predetermined action on a shaped object displayed on a video display in order to gain access to the server.

The cited prior-art documents and the available prior-art documents have certain drawbacks, few of them are listed below:
1. The machine readable resistant security media object (such as images) on which text is embedded are not secure and can be spoofed.
2. The browser malware/proxy Trojan may forward the traffic to dedicated persons employed for extracting the critical details from machine readable resistant security media object (such as images), modifying these critical details obtained as per fraudster and then embedding these modified critical details within some similar machine readable resistant media object which is then sent to the naive user for transaction confirmation.
3. The parameters that are used to embed the transaction details on the images or some other machine readable resistant security media object are not user specific, but generic and can be therefore compromised.
4. Further, the undesirable modifications attempted by MitB and similar attacks in a financial transaction issued online by the user can go undetected. The attacker (like MitB-Zeus Trojan) can sit in the browser and change the transaction contents or insert additional transactions in a way, unknown to the user and the bank, wherein the user is shown the original information, same as what he entered for the transaction but in turn, the attacker/Trojan sends a different information (unknown to the user) to the bank server, etc.

Though, all the above mentioned methods were proposed to provide a secure mechanism against computer security attacks, and while the techniques for protecting against computer security attacks (phishing, MitB attacks, etc.) are growing, there still exists a need to enhance security against these attacks, and hence there exists a need to propose an enhanced secure authentication system and method thereof.

### SUMMARY

This summary is provided to introduce concepts related to systems and methods of security enhancement for communication with authentic system that enhances security against phishing, Man-in-the-Browser (MitB) and similar attacks using a set of multimedia contents particular to a user and user specified parameters, and the concepts are further described below in the detailed description. This summary is not intended to identify essential features of the claimed subject matter nor is it intended for use in determining or limiting the scope of the claimed subject matter.

For security purposes, authentication is required during the login session for a user to verify the authenticity of the network communication and/or the host system (corresponding to some financial institution(s), bank(s), funding organization(s) and the like) and vice-versa. Authentication is also required during a transaction (like in financial transaction) for verifying the integrity of the actual content of the transaction between the user and the host system. The word “authentication” hereby is used to include both the contexts, but is not limited to these. In later case, confirming the authentication would imply authenticating the desired transaction between the user and the host system. In former case, confirming the authentication would imply the host system allowing access to the user after confirming correctness of the user input (password, OTP, etc), that user provided after affirming the authenticity of the host system.

It is one of the objectives of the present invention to enable user access to a legitimate host system.

It is another objective of the present invention to detect any undesirable modifications attempted by MitB and the like attacks in a financial transaction issued online and to prevent them.

It is another objective of the present invention that enables the user to verify if the response received is coming from a valid authenticating server and based on the verification, user decides and provides their input to proceed further with the authentication.

Accordingly, in one implementation, a method for providing authentication between a user system and a host system is disclosed. The method comprises:
receiving, from a user, a set of at least one user specified multimedia content and a set of user specified parameters;
storing, said set of at least one user specified multimedia content and said set consisting of user specified parameters, using said host system;
receiving, from said user system, information associated with said authentication by said user of said user system;
embedding, a critical information based on said information received, using a set of user specified parameters and random parameters selected using said host system in said one or more user specified multimedia content stored, thereby
modifying one or more user specified multimedia content stored into modified multimedia content;
transforming the modified multimedia content into an authenticating multimedia content, sending, from said host system to said user system, said authenticating multimedia content and related information;
presenting said authenticating multimedia content and related information, to said user so that said authenticating multimedia content is perceivable by said user;
receiving, an input from said user, the input indicating verification of said authenticating multimedia content and for proceeding said authentication; and
performing said authentication using said host system, based on said input received from said user.

In one implementation, a method for authenticating a user during an authentication involving said user and a host system is disclosed. The method comprises using said host system, to receive from said user, a set of at least one user specified multimedia content and a set of user specified parameters; to store said set of at least one user specified multimedia content and said set consisting of user specified parameters; to receive from a user system, information associated with said authentication from said user; to embed a critical information based on said information associated with said authentication, received, using said set of user specified parameters and random parameters selected using said host system in said one or more user specified multimedia content stored, to thereby modify this said multimedia content into the modified multimedia content, to transform said modified multimedia content into an authenticating multimedia content; to send said authenticating multimedia content and related information to said user system that is accessible by said user; to receive input from said user, the input indicating verification of said authenticating multimedia content and for proceeding said authentication; and perform said authentication using said host system based on said input received from said user.

In one implementation, a host system for performing an authentication using a user system is disclosed. The host system comprises of a processor; and a memory coupled to the processor for executing a plurality of modules present in said memory. The said memory comprises of a processing module, an embedding module, a transmitting module, and an authenticating module. The processing module configured to receive a set of at least one user specified multimedia content and a set of user specified parameters from the user; receive information associated with said authentication from said user of said user system; and receive an input from said user, the input indicating verification of an authenticating multimedia content and for proceeding said authentication. The embedding module is coupled to said processing module and is configured to create said authenticating multimedia content, by embedding a critical information concerning said authentication using a set of said user specified parameters and random parameters, in one or more user specified multimedia content stored, thereby modifying one or more user specified multimedia content into modified multimedia content, and then transforming the modified multimedia content into an authenticating multimedia content. The transmitting module is coupled to the embedding module and said processing module and is configured to send said authenticating multimedia content and related information to said user. The authenticating module coupled to the said processing module and transmitting module and is configured to perform said authentication based on said input received from said user.

The proceeding summary is intended to serve as an introduction to some embodiments of the invention. It is not meant to be an introduction or overview of all inventive subject matter disclosed in this document. The detailed description that follows and the drawings that are referred to in the detailed description will further describe the embodiments described in the brief summary as well as other embodiments. Accordingly, to understand all of the embodiments described in this document, a full review of the summary, detailed description and the drawings is needed. Moreover, the claimed subject matter is not to be limited by the illustrative details in the summary, detailed description and the drawings, but rather is to be defined by the appended claims, because the claimed subject matter can be embodied in the other specific forms without departing from the protection scope of the invention.

### BRIEF DESCRIPTION OF THE ACCOMPANYING DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a high-level block diagram of an authenticating system (100) according to an embodiment of the present invention;

FIG. 2 illustrates a block diagram illustrating a host system (106) according to an embodiment of the present invention;

FIG. 3 illustrates a method for authenticating system (100) according to an embodiment of the present invention;

FIG. 4 illustrates a method performed by a host system (106) in authenticating system (100) according to an embodiment of the present invention;

FIG. 5 illustrates a user interface visible on user system (102) for initiating a transaction authentication request, according to an embodiment of the present invention;

FIG. 6 illustrates a traditional user interface visible on user system (102) as a confirmation page corresponding to said transaction authentication request as per the conventional approach;

FIG. 7 illustrates a user interface visible on user system (102) as a confirmation page corresponding to said transaction authentication request, as per the proposed approach, according to an embodiment of the present invention;

FIG. 8 illustrates a user interface visible on user system (102) as a confirmation page corresponding to said transaction authentication request, as per the proposed approach wherein the proposed approach makes user aware of the attack, according to an embodiment of the present invention;

FIGS. 9(a), (b), (c), (d), (e), (f), (g), (h) and (i) illustrate some examples of elements of MCSPU and authenticating multimedia content as per proposed approach, according to an embodiment of the present invention;

FIGS. 10(a), (b), and (c) illustrates a user interface visible on user system (102) during a login authentication process, according to an embodiment of the present invention.

### DETAILED DESCRIPTION OF THE EMBODIMENTS

A detailed description of the invention is provided below. While the invention is described along with several embodiments and illustrative drawings, it should be understood that the invention is not limited to any one embodiment, but instead includes numerous equivalents. For example, while most of the embodiments are described in the context of images as authenticating multimedia content, those skilled in the art will recognize that the disclosed systems and methods are readily adaptable for other multimedia contents as well. For example, without limitation, the present invention could be readily applied in the context of video and audio files as authenticating multimedia content. In addition, for providing a thorough understanding of the present approach, numerous specific details are set forth in the following description; the present approach may be practiced by not including all or some of these details. Moreover, for the purpose of clarity, certain technical material that is known in the art related to the invention has not been described in detail in order to avoid unnecessarily obscuring the present invention.

Systems and methods for enhancing security against phishing, Man-in-the-Browser (MitB) and similar attacks using multimedia content set particular to user and user specified parameters are described. Firstly, a user provides a set of multimedia contents (that may be a set of images), i.e. Multimedia Content Set Particular to User (herein after, MCSPU), by either visiting the nearest branch of the host institution/system that may include financial institutions, banks, funding organizations and the like, or via some secure communication medium. User can also choose for the host institution to allocate the set of multimedia contents specific to the user. Herein after, the present invention will be explained with an example of images as a set of multimedia content and it should be understood that the set of multimedia content is not limited to only images but maybe selected from a group comprising of an image, an audio, a video, an animation, and combinations thereof. It is also understood that the user specified parameters, processing steps (embedding, transforming, etc.) mentioned herein, seems more specific with the use of images as multimedia content, but similar concepts as applicable for the other multimedia contents are also included within the scope of present invention. Further, it is also understood by the ordinary person that the soft versions of hardware files having the properties of multimedia may also be used as input to the present system.

Further, for the confirmation of authentication, at that time the host system uses: one or more elements (e.g. images) selected from MCSPU; embedded with the critical information (OTP, account number, amount of money to be transferred, user id etc.) using the user specific parameters that are specified by the user, and after that performs some transformations on the MCSPU's element embedded with the critical information.

It is also well understood by a person skilled in the art that the critical information embedded may not be limited to only text but may include other multimedia as its contents to be embedded.

Further, the host system may also use the concept of splitting critical information across two or more multimedia contents which are presented on the confirmation HTML page at random places.

Further, at times like in case of some suspicious user behavior (for e.g. trying financial transactions at odd times, multiple transactions involving unusual huge amount of money, money transfer to foreign accounts, or transactions from different or unknown IP, etc.) the host system may also reply with plurality of random multimedia content or just some non-user specific multimedia content (embedded with critical information) or use embedding parameters not specific to user, so only legitimate user confirms the authentication or else authentication is cancelled or suspicious user is put to honey pot trap. It is well understood by the person skilled in the art about the honey pot trap.

The present invention proposes a security method that may be strengthened by embedding within one or more elements(an image, for example) from MCSPU, the critical information text having one or more of the following properties: using different font styles, stroke-width and/or colors for the embedded text characters/symbols; orienting different text characters at different angles (user specified);varying transparency and/or inter-character distance of the embedded text randomly; embedding critical information along some random/user-specified curved path (quadratic, sinusoidal, etc.) having random origin and random scaling; Using a combination of region specific characters, alphanumeric and/or other characters/symbols (very useful against global threats) Integrating OOB (Out of band) (a split OTP—for example, a part of OTP sent via SMS and other part displayed using MCSPU's element) or critical information coded using encoded data that's there on user's debit card grid.

Then this MCSPU's elements with embedded critical information undergo random transformation(s) before being sent by the host server (authenticating server) to the user for confirmation. For example, if MCSPU's element is an image, the transformation applied could be some perspective projective transformations (such as skewing, scaling, rotating, warping, etc), distortions, identity transformation, and/or rotations. This may prevent fraudsters and malicious software from obtaining the original element(s) of MCSPU.

While aspects of described system and method for enhancing security against phishing, MitB and/or similar attacks using MCSPU and user specified parameters may be implemented in any number of different computing systems, environments, and/or configurations, the embodiments are described in the context of the following exemplary system.

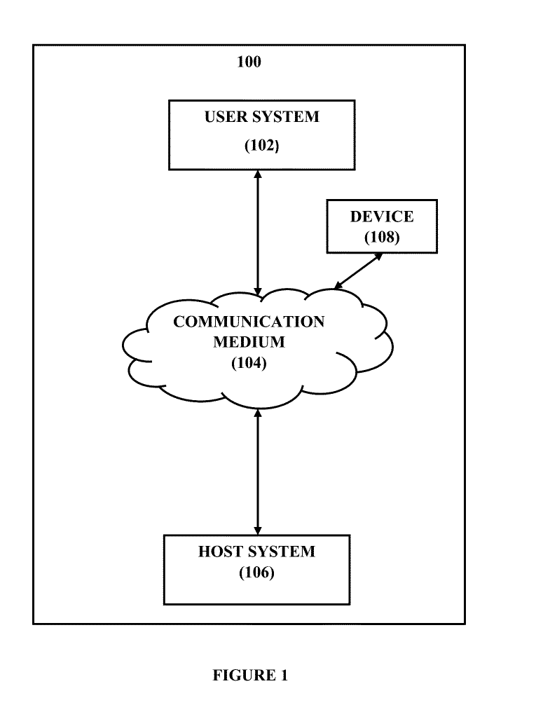

Referring now to FIG. 1 is a high-level block diagram showing the various broad hardware components of an authentication system 100 according to the present invention. As shown, system 100 comprises user system 102 coupled to Host system 106 through communication medium 104. The connections are typically TCP/IP (Transmission Control Protocol/Internet Protocol) connections, but other connections and protocols are also possible. For example, the connection between user system 102 and host system 106 might be a SLIP/PPP (Serial Link IP/Point-to-Point Protocol) connection, wireless connection, or the like. The Communication medium 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the Communication medium 106 may include a variety of network devices, including routers, bridges, servers, computing devices, storage devices, and the like.

In one embodiment, user system 102 may be a desktop computer configured to communicate to other computer systems over a plurality of communication mediums. Host system 106 may be a server, e.g., located at a financial institution. Communication medium 106 may be internet, wireless medium, wired connection, or the like. In one implementation, the Communication medium 106 may be a wireless network, a wired network or a combination thereof.

Although the present subject matter is explained considering that the Host system 106 is implemented as a server, it may be understood that the host system 106 may also be implemented in a variety of computing systems, such as a laptop computer, a desktop computer, a notebook, a workstation, a mainframe computer, a server, a network server, and the like. It will be understood that the Host system 106 may be accessed by multiple users through one or more the user systems 102, or applications residing on the user system 102. Examples of the user system 102 may include, but are not limited to, a portable computer, a personal digital assistant, a handheld device, and a workstation.

In a secured environment, host system 106 can communicate with user system 102 without anyone eavesdropping or intercepting the communication between them. However, in certain instances, e.g., MitM, an attacker may insert a MitM system between the host system and the user system in order to gather sensitive information, as described above.

In one implementation, the host system may have alternate ways to gather the user specific multimedia content, such as through a USB slot or a CD drive or means for capturing image, audio, video or other multimedia content from user, or the like similar ways.

In one implementation, a device (108) is provided to enable the user to submit one or more user specified multimedia content, wherein said device (108) is selected from a group of sensing devices comprising of a camera, a scanner, an audio recording device, a video recording device, a biometric device, and combinations thereof. The user may submit the multimedia content onto the system 106 or select the multimedia pre-stored in the system 106. Further, in an embodiment, the user may send a hardcopy of the multimedia for example an image to the host institution and security personnel may scan the image for the user and submit it to the system 106.

In one implementation, the system (106) performs an authentication based on an input received from a user, wherein the input indicates verification of an authenticating multimedia content and for proceeding said authentication.

Embodiments of present invention may prevent or reduce security threats (such as phishing, MitB) and other attempts to intercept and decipher communications between host system 106 and user system 102 by implementing an authentication process including a two-factor test. The two-factor test may include, as a first step, the host system 106 presenting the user, through user system 102, with an authenticating multimedia content and related information associated with said authentication. The second step may require the user to verify this before confirming the authentication.

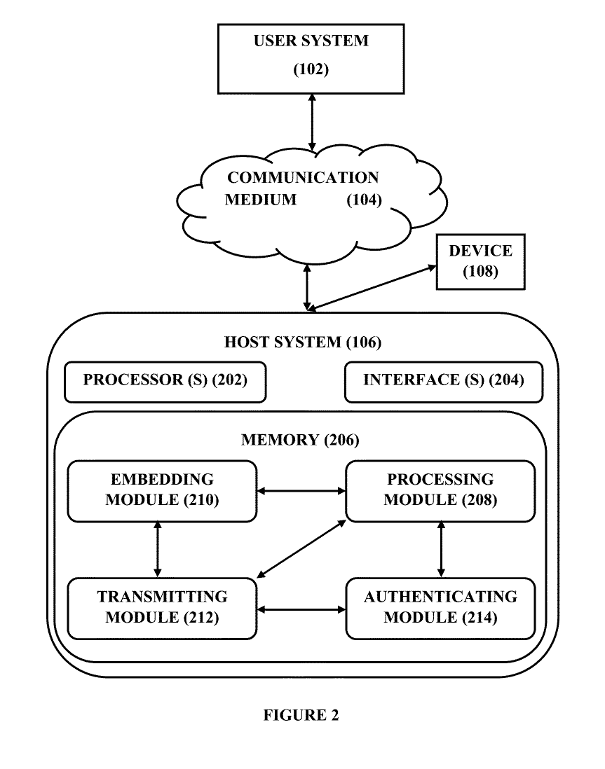

Referring now to FIG. 2 is a block diagram illustrating a host system (106) according to an embodiment of the present invention. In one embodiment, the host system 106 may include at least one processor 202, an input/output (I/O) interface 204, and a memory 206. The processor 202 may be implemented as one or more microprocessors, microcomputers, microcontrollers, digital signal processors, central processing modules, state machines, logic circuitries, and/or any devices that manipulate signals based on operational instructions. Among other capabilities, the processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the host system 106 to interact with a user directly or through the client devices 108 and user system 102. Further, the I/O interface 204 may enable the host system 106 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206may include plurality of modules.

The modules include routines, programs, objects, components, data structures, etc., which perform particular tasks or implement particular abstract data types. In one implementation, the modules may include a processing module (208), an embedding module (210), a transmitting module (212), and an authenticating module (214).

In one implementation, a host system (106) for performing an authentication with a user system (102) is disclosed. The host system (106) comprises of a processor (202); and a memory (206) coupled to said processor (202) for executing a plurality of modules present in said memory (206). The memory comprises of the processing module (208), the embedding module (210), the transmitting module (212), and the authenticating module (214)

The processing module (208) is configured to receive a set of at least one user specified multimedia content (MCSPU) and a set of user specified parameters from the user; receive an information associated with said authentication from said user of said user system (102); and receive an input from said user, the input indicating verification of an authenticating multimedia content and for proceeding said authentication The embedding module (210) is coupled to the processing module (208) and configured to create said authenticating multimedia content, by first embedding a critical information concerning said authentication using a set of said user specified parameters and random parameters, in said one or more user specified multimedia content selected using said host system (106) from MCSPU, thereby modifying one or more user specified multimedia content into modified multimedia content; and then transforming said modified multimedia content into an authenticating multimedia content.

The transmitting module (212) is coupled to the embedding module (210) and is configured to send said authenticating multimedia content and related information to said user. The authenticating module (214) is coupled to the processing module (208) and said embedding module (210), and is configured to perform said authentication, based on said input received from said user. In one implementation, the authenticating multimedia content is characterized by said critical information using said user prescribed parameters selected by said user. In one implementation, the user specified multimedia content is selected from a group comprising of an image, an audio, a video, an animation, and combinations thereof.

In one implementation, the information associated with said authentication comprise of an information about user, account details, user id, random passcode specified by user, transaction details, debit account details, credit account details, an amount of money or any other asset to be transferred, information about host system, one time password (OTP), and combinations thereof.

In one implementation, the critical information is based on said information associated with said authentication and any other information selected from a group comprising an amount of money or any other asset to be transferred, transaction details, debit account details, credit account details, user id, random passcode specified by user, information about host system, one time password (OTP), and combinations thereof.

In various embodiments, the location of critical information within the selected multimedia content may be randomized across multiple authentications. For example, for each of multiple authentications, the critical information may be located at different positions in the image or at different times in the video. This may prevent fraudsters from locating and modifying the critical information.

In one implementation, the host system selects at least one element from MCSPU randomly which is then used to generate authenticating multimedia content to send to said user system for authentication. In one implementation, the related information sent in addition to authenticating multimedia content by host system (106) to said user for said authentication during the login session or the transaction may comprise of an information about user, user name, random passcode specified by user, an information about host system, OTP from the host system, instructions and precautions for safe online authentication experience, virtual keyboard, and combinations thereof. The related information for authentication of the financial transaction may further include transaction details, an amount of money or any other asset to be transferred, debit or credit account details, and combinations thereof.

In one implementation, the host system (106) comprises of a device (108) coupled with said host system for receiving one or more multimedia content particular to user, wherein said device (108) is selected from a group comprising of a camera, a scanner, a headphone, a video recording device, a biometric device, and combinations thereof.

In one implementation, the user prescribed parameters and random parameters are selected from a group comprising of: one or more languages, font styles, stroke-width and/or colors of said critical information; orientation of said critical information within a range of different angles as prescribed by said user; location of said critical information within the said multimedia content; transparency and/or inter-character distance of said critical information; linguistic and paralinguistic characteristics of the voice which are effected by parameters such as pitch, duration, loudness, timbre and/or other aspects of vocal quality; video or animation characteristics including number of frames per second, interlaced or progressive, aspect ratio, color space and bit depth, video quality, stereoscopy, compressor (or codec) and/or similar attributes; some random or user-specified curved path for embedding the said critical information that may have random origin and/or random scaling; a combination of region specific characters, alphanumeric and/or other characters/symbols in said critical information; and partial/full integration of out of band (OOB) authentication or critical information coded using encoded data and combinations thereof.

In one implementation, the critical information concerning said authentication is embedded completely or partially in said one or more elements from MCSPU stored.

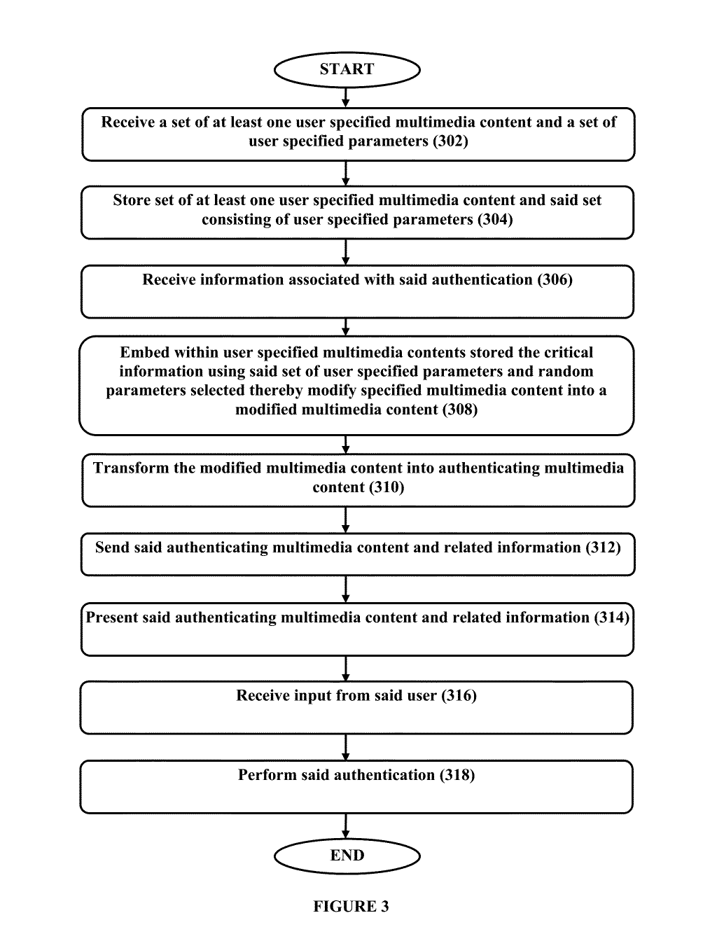

Referring now to FIG. 3 is a method for authenticating system (100) according to an embodiment of the present invention. The method may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

The order in which the method is described is not intended to be construed as a limitation, and any number of the described method blocks can be combined in any order to implement the method or alternate methods. Additionally, individual blocks may be deleted from the method without departing from scope of the subject matter described herein. Furthermore, the method can be implemented in any suitable hardware, software, firmware, or combination thereof. However, for ease of explanation, in the embodiments described below, the method may be considered to be implemented in the above described host system 106.

At block 302, a set of at least one user specified multimedia content and a set of user specified parameters are received from a user.

At block 304, said set of at least one user specified multimedia content and said set consisting of user specified parameters are stored using said host system (106).

At block 306, information associated with said authentication from said user of said user system (102) is received from said user system (102). At block 308, a critical information using a set of user specified parameters and random parameters selected using said host system (106) is embedded in said one or more user specified multimedia content stored (one or more elements from MCSPU stored) to thereby modify one or more user specified multimedia content stored into modified multimedia content.

At block 310, the modified multimedia content is then transformed into an authenticating multimedia content by introducing some random transformations. For e.g. if the multimedia content in consideration is an image, the transformations applied on said multimedia content could be some perspective projective transformations (such as skewing, scaling, rotating, warping, etc.), distortions, and/or rotations. At block 312, said authenticating multimedia content and related information is sent to the user system (102) from said host system (106).

At block 314, said authenticating multimedia content is presented, on said user system (102) so that said authenticating multimedia content is perceivable by said user.

At block 316, an input is received from said user system (102), the input indicating verification of said authenticating multimedia content and for proceeding said authentication. The input received comprises login request, confirmation request, cancellation request, user password, security codes, OTP, account details, and combinations thereof.

At block 318, said authentication using said host system (106) based on said input from said user (102) is performed. In one implementation performing said authentication may include but not limited to cancelling the said authentication if said user provided input to cancel said authentication. For authentication during login session, performing said authentication includes verifying the correctness of the user password and/or OTP received from said user as said user input, and accordingly providing access to the said user. For authentication of transaction, if OTP was provided by the said host system to said user, automatically performing said authentication includes verifying the correctness of OTP received from said user, as the said input and then performing the transaction accordingly. Else, if the OTP was not provided by the host system, the host system authenticates or cancels the transaction as per user's confirmation or cancellation request, respectively. The authenticating multimedia content is selected from a group comprising of an image content, an audio content, a video content, an animated content, and combinations thereof, and said critical information embedded in said authenticating multimedia content is tamper resistant and not machine readable.

In one implementation a set of at least one user specified multimedia content and said set of user specified parameters is provided by said user using a device or selected from a set of pre-stored options on the said host system. Said set of pre-stored options include some multimedia content pre-stored in the system 106 and user specified parameters set with some default options in the system 106. In one implementation, said critical information concerning said authentication is embedded completely or partially in said one or more elements from MCSPU stored.

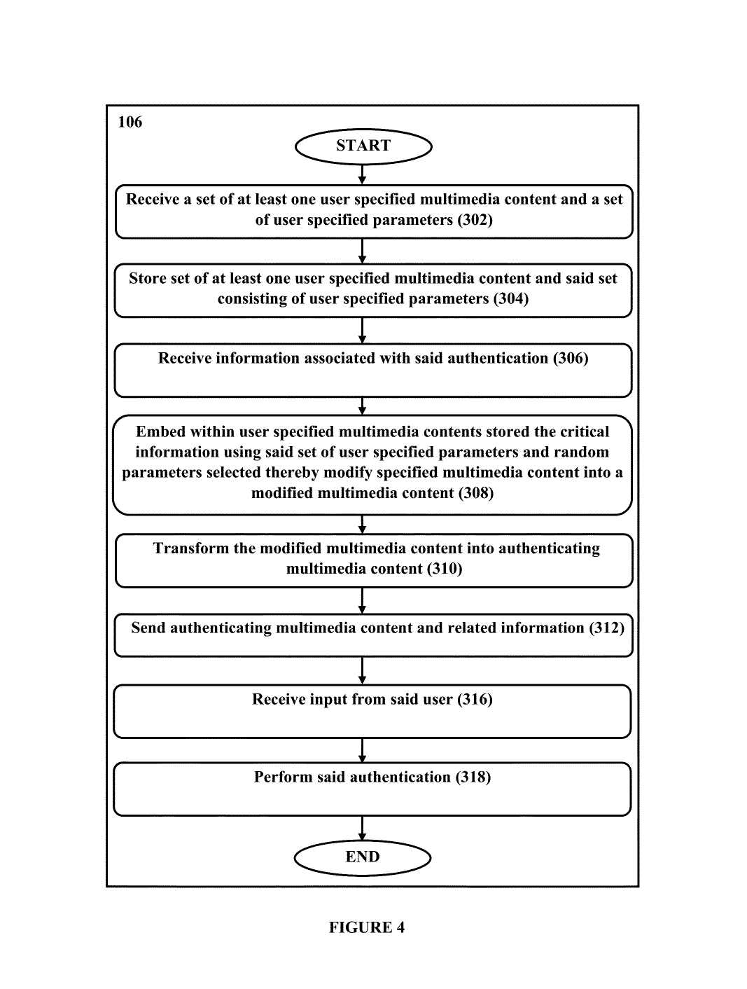

Referring now to FIG. 4 is an illustration of a method performed by a host system (106) in authenticating system (100) according to an embodiment of the present invention. The method has the steps performed by the host system 106. The method comprises the steps as disclosed in the details of FIG. 3, except that the step at block 314 is not performed at the host system (106). Further, it is understood that the steps 302 to 312 and steps 316 and 318 are performed in similar manner as performed and explained in FIG. 3, hence unnecessary repetition of steps herein is omitted.

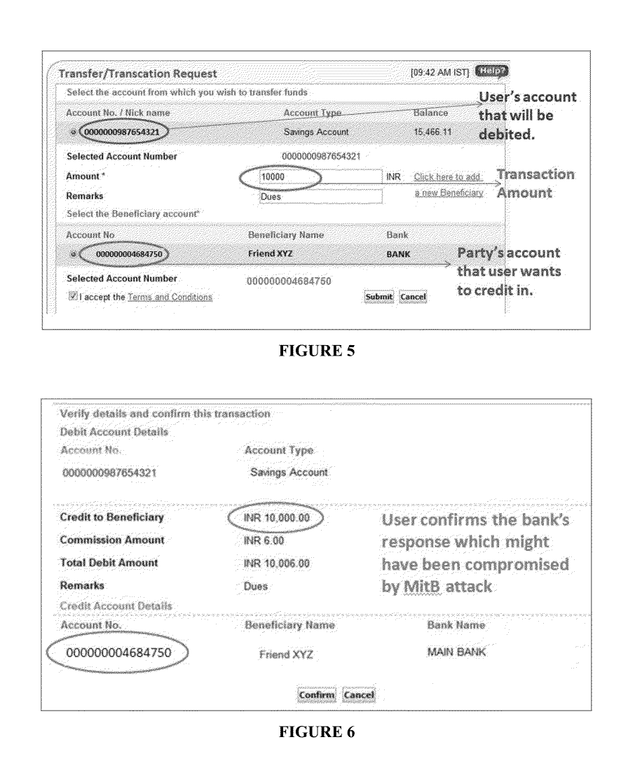

Referring now to FIG. 5 is a user interface visible on user system (102) for providing the information for making an authentication request (financial transaction request in this case). In one example, user requests to transfer the money to Friend XYZ whose account no. is 000000004684750.

FIG. 6 illustrates a traditional user interface visible on user system (102) as a confirmation page sent by the bank as per the conventional approach. This could have been intercepted by MitB like attacks without user coming to know about the modifications. MitB may change the transfer recipient account number to 000000002344321 (and may also modify the amount of authentication). Bank receives the modified request and in traditional approach, responds with the confirmation page which again is then modified by MitB in order to display the account number that user had initially provided. The modifications are not detected by the said user and user confirms the transaction, and MitB attack succeeds in duping the user

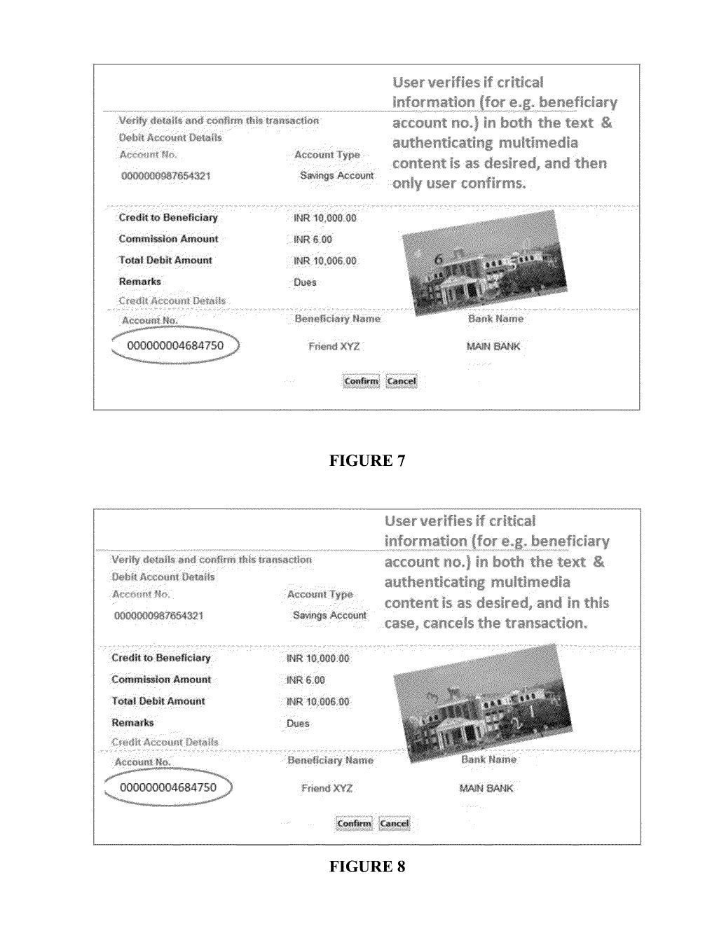

FIG. 7 illustrates a user interface visible on user system (102) as a confirmation page sent by the bank according to an embodiment of the present invention. Consider image as shown in FIG. 7 as the authenticating multimedia content created using one of the elements of MCSPU (an image of a University Building, in this example) and the last seven digits of beneficiary account number, used here as critical information, embedded within the selected MCSPU element using the user-specified parameters. Bank received said transaction request of said user and responded with the confirmation webpage having also the authenticating multimedia content. User verifies that the transaction request received by the bank is same as desired by him/her, and then only, user confirms the transaction. The authentication is hence performed and the requested amount of money is transferred then from said user account number to the desired beneficiary account number.

FIG. 8 illustrates a user interface visible on user system (102) wherein a proposed approach makes user aware of the attack according to an embodiment of the present invention. Consider, MitB modified the transfer recipient account number to 000000002344321 and the Bank receives the modified request. The bank responds with authenticating multimedia content created using one of the elements of MCSPU (an image of a University Building, in this example) and the last seven digits of beneficiary account number i.e. 2344321, used here as critical information, embedded within the selected MCSPU element, using the user-specified parameters, in this embodiment of the present invention. In one example, MitB changes the text portion in the response but cannot change the critical information that is embedded within the MCSPU element (an image in this example). The irregularities in the bank response are detected by the user and user cancels the transaction, and the MitB attack fails completely.

It is to be noted that, the proposed approach enhances the security because for MitB to break this authentication method, it needs to have access to the original multimedia contents and the user specific parameters to embed the fraudulent account number. However this may not be possible as the original multimedia contents are with the host server and the user only. Also, to reverse engineer the authenticating multimedia contents to access the original multimedia contents and the user specific parameters that are used for embedding critical information, followed by fraudster modifying it and preparing the authenticating multimedia content that can falsely assure authenticity of the bank response, in real time for attack to succeed, the technology required neither exists nor seems possible to the best of our knowledge as this is an extremely sophisticated task requiring just for images as multimedia content the procedures such as text detection, user-specific parameters identification, text extraction or modification, image in painting or restoration, and text insertion into the image using user specific parameters. Text detection is for detecting the text information within the natural scene image. Text extraction/modification is needed for extracting from the detected text, that text only which corresponds to the critical information as modified by the fraudster. Other information details like OTP, bank name, user-specified tag etc. need to be left unchanged. Attacker also need to understand and identify the user specific parameters used for embedding the critical information text e.g. curved path, orientation angle, language (Indian, Japanese, English etc.), transparency, scaling parameters, color, font style, etc. image in painting/restoration is performed then for those regions within the image that need to be filled from their surrounding regions without introducing any artifacts else user can easily get suspicious of some modifications being made by fraudster. Lastly, fraudster need to insert/embed the text corresponding to the original transaction requested by the said user and that too, embedding using the user-specified parameters. For other multimedia content like videos, the processing required to access original multimedia content and the user specified parameters would be even more complicated.

Although, automatic text extraction is still a very challenging problem especially with the variation of text due to differences in size, style, orientation, and alignment, but if one were to use just only one user specific personal image, and not use the set of several multimedia content elements particular to user and user specified parameters as proposed in present invention; it is not that sophisticated and foolproof since there also exists possibility to recreate the original user specific personal image via majority voting after collecting many samples of the images that are used during the transactions performed by the user and the host server/bank. Further, the proposed system randomly transforms the modified multimedia content to make it more challenging to obtain the original elements of the multimedia content set particular to user.

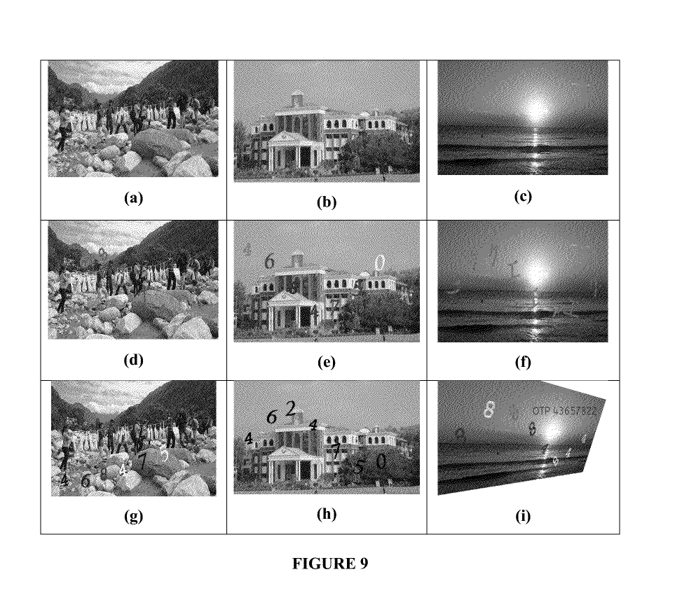

FIGS. 9((a), (b), (c), (d), (e), (f), (g), (h) and (i)) illustrate a proposed approach according to an embodiment of the present invention. The FIGS. 9(a), (b), and (c) are the exemplary image elements of MCSPU. The FIGS. 9(d), (e), (f), (g), (h) and (i) are the authenticating multimedia content (images in this example) with the critical information embedded within the corresponding elements of MCSPU, using different user specific parameters (curved paths used, language used, color etc). The exemplary authenticating multimedia content images as shown in FIGS. 9(d), (e), (f), (g), and (h) is created from their corresponding modified multimedia content images after using identity transformation. The exemplary authenticating multimedia content image as shown in FIG. 9(f) has critical information embedded using Japanese language. The exemplary authenticating multimedia content image as shown in FIG. 9(i) is created from its modified multimedia content image after using transformations such as skewing, warping, scaling etc.

The security approaches currently used by several major websites include CAPTCHA schemes, mostly text based schemes where the user is presented with some simple image having the unknown text (or say, pass-code) that user need to identify and enter to get authenticated. The user may refresh the CAPTCHA image to try other pass-code without having any other impact. Also, several CAPTCHA breaking tools both automated and manual are already available in the market. Further, in CAPTCHA generally the text that appears in the generic image is unknown to the user, and there is also no role of user specified embedding parameters. In the present invention, the MitB attack is already well aware of the critical information (account no., amount etc.) that is embedded within the image by the host server. The information is already known to attacker. MitB aims to exchange that critical information details (embedded within the image from MCSPU) with the details requested by the user in original authentication. The user only provided part of the critical information that is expected to appear in the MCSPU image/multimedia contents. Critical information is embedded according to user specified parameters. Here, no option to refresh is provided. Complete authentication either cancelled or authenticated.

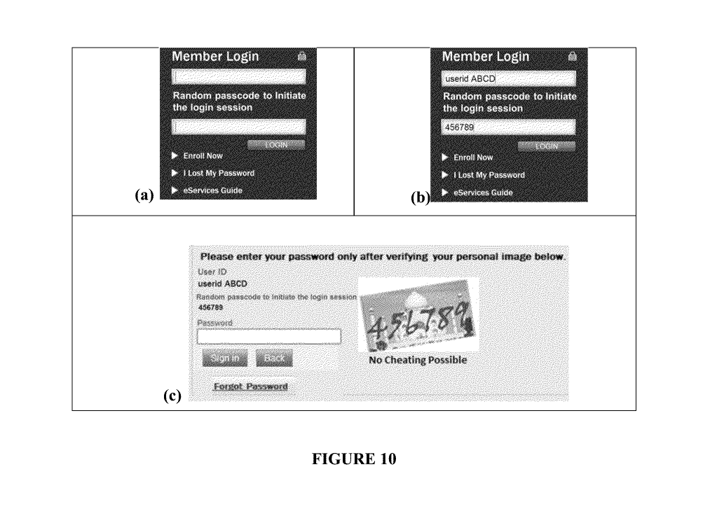

Referring now to FIGS. 10((a), (b) and (c)), the user interface visible on user system (102) during a login authentication process is disclosed, according to an embodiment of the present invention. FIG. 10(a) illustrates the user/member login page in the beginning before user attempts to login with his/her credentials. FIG. 10(b) illustrates the user attempting to login with his/her credentials -using username as “userid ABCD” and user provided random passcode to initiate the login session as “456789”. The host system uses this random passcode as the critical information and embeds this critical information within a user specified stored multimedia content (“TajMahal image”) and responds with this authenticating multimedia content and user phrase as “No Cheating Possible”, which ensures the user the authenticity of host system, and user may then confirm this and enter his password to proceed further in said authentication.

Although implementations for enhancing security against MitB, Phishing and similar attacks using MCSPU and user specified parameters have been described in language specific to structural features and/or methods, it is to be understood that the disclosed description is not necessarily limited to the specific features or methods described. Rather, the specific features and methods are disclosed as examples of implementations for enhancing security against MitB, Phishing and similar attacks using multimedia content set particular to user and user specified parameters.

Exemplary embodiments discussed above may provide certain advantages. The present invention also provides other advantages though not limited to the below mentioned, these advantages may include:
1. Automatic text extraction is still a very challenging problem especially with the variation of text due to differences in language, size, style, orientation, and alignment. Many OCR tools (like Microsoft Endnote, Abby Fine Reader etc.)—perform poorly in extracting text from natural scene images. The proposed approach involves multimedia contents and user specified design parameters making it much more complex than just using any random image that is not specific to the user/client making authentication.
2. Extracting the original multimedia content after removing the embedded critical information is an essential first step to cause an attack on the proposed system. An attacker first need to extract the original multimedia content and then embedded some wrong information in it. Extracting the original multimedia content is much harder problem then just extracting the embedded critical information. Doing this in real time is even tougher. This makes the system very secure.
3. The present systems rely only on the embedded information while the proposed system provides additional security by utilizing the correctness of embedding medium (multi-media content) as well as some of the parameters used for embedding. Even if the attacker gains some access to the multimedia content embedded with critical information, he cannot gain access to the user specified parameters. These parameters may even be dynamic such as clockwise rotation of text or anticlockwise rotation depending upon if the date is even or odd.
4. The presented approach is very user friendly and efficient as compared to the existing approaches in the market.

Finally, it should be understood that the above embodiments described with several flow diagrams, are only used to explain, but not to limit the technical solution of the present invention and the invention is not to be limited to the specific details given herein. The methods described herein may be implemented in software, hardware, or a combination thereof, in different embodiments. In addition, the order of the steps of the methods may be changed, and various elements may be added, reordered, combined, omitted, modified, etc. The use of flow diagrams is not meant to be limiting with respect to the order of operations performed. Many variations, modifications, additions, and improvements are possible.

Accordingly, plural instances may be provided for components described herein as a single instance. Further, the boundaries between various components, operations and storage modules are somewhat arbitrary and are illustrated in the context of specific illustrative embodiments. Other allocations of functionality are envisioned and may fall within the scope of claims that follow.

Finally, structures and functionality presented as discrete components in the example configurations may be implemented as a combined structure or component. The detailed description of the present invention with reference to above preferred embodiments has been presented for purposes of illustration, clarity and of description. It is not intended to be exhaustive or limiting with respect to the precise form disclosed and various modifications, changes or equivalent replacements can be made by those skilled in the art or may be acquired from practice of the disclosed embodiments without departing from the scope of the present invention and covered in the claims appended hereto and their equivalents. For example, while transformation of modified multimedia content is mainly described for images, appropriate transformations such as replay speed or frames per second may be used for transforming the modified multimedia content if it is audio or video.

1. A method for authentication, between a user system and a host system, the method comprising:
receiving from a user, a set of at least one user specified multimedia content and a set of user specified parameters;
storing said set of at least one user specified multimedia content and said set consisting of user specified parameters, using said host system;
receiving from said user system, information associated with said authentication from said user;
embedding using said host system, a critical information based on said information received, using said set of user specified parameters and random parameters, in said one or more user specified multimedia content stored, thereby modifying one or more user specified multimedia content stored into modified multimedia content;
transforming said modified multimedia content into an authenticating multimedia content;
sending from said host system to said user system, said authenticating multimedia content and related information;
presenting to said user, said authenticating multimedia content and related information, wherein said authenticating multimedia content is perceivable by said user;
receiving an input from said user, the input indicating verification of said authenticating multimedia content and for proceeding said authentication; and
performing said authentication, using said host system, based on said input received from said user.

2. The method according to claim 1, wherein said multimedia content is selected from a group comprising of an image, an audio, a video, an animation, and combinations thereof.

3. The method according to claim 1, wherein said user prescribed and random parameters are selected from a group of parameters comprising:
one or more languages, font styles, stroke-width and/or colors of said critical information; or
orientation of said critical information within a range of different angles as prescribed by said user; or
location of said critical information within the said multimedia content; or
transparency and/or inter-character distance of said critical information; or
linguistic and paralinguistic characteristics of the voice which are effected by parameters such as pitch, duration, loudness, timbre and/or other aspects of vocal quality; or
video or animation characteristics including number of frames per second, interlaced or progressive, aspect ratio, color space, bit depth, video quality, stereoscopy, compressor (or codec) and/or similar attributes;
some random or user-specified curved path for embedding the said critical information that may have random origin and/or random scaling; or
a combination of region specific characters, alphanumeric and/or other characters/symbols in said critical information; or
partial/full integration of out of band (OOB) authentication or critical information coded using encoded data; or any combination thereof.

4. The method according to claim 1, wherein said set of at least one user specified multimedia content and said set of user specified parameters is provided by said user using a device and/or selected from a set of pre-stored options on the said host system.

5. The method according to claim 1, wherein said critical information embedded in said specified multimedia content stored is tamper-resistant and not machine-readable.

6. The method according to claim 1, wherein said information associated with said authentication is selected from a group of information comprising:
an information about user, account details, user id, random passcode specified by user, transaction details, debit account details, credit account details, an amount of money or any other asset to be transferred, information about host system, one time password (OTP), or any combination thereof.

7. The method according to claim 1, wherein said critical information is based on said information associated with said authentication and any other information selected from a group of critical information comprising:
an amount of money or any other asset to be transferred, transaction details, debit account details, credit account details, user id, random passcode specified by user, information about user, information about host system, one time password (OTP), and combinations thereof.

8. The method according to claim 1, wherein said critical information associated with said authentication is embedded completely or partially in said one or more user specified multimedia content stored.

9. A host system for performing an authentication with a user system, said host system comprising:
a processor; and
a memory coupled to said processor for executing a plurality of modules present in said memory, said plurality of modules comprising:
a processing module configured to:
receive a set of at least one user specified multimedia content and a set of user specified parameters from the user;
receive information associated with said authentication from said user of said user system; and
receive an input from said user, the input indicating verification of an authenticating multimedia content and for proceeding said authentication;
an embedding module coupled to said processing module and configured to:
create said authenticating multimedia content by embedding a critical information based on said information received, using said set of user specified parameters and random parameters, in one or more user specified multimedia contents stored; and thereby modifying one or more user specified multimedia content into modified multimedia content; and
transforming said modified multimedia content into an authenticating multimedia content;
a transmitting module, coupled to said embedding module and said processing module, and configured to:
send said authenticating multimedia content and related information to said user; and
an authenticating module, coupled to said processing module (208) and said transmitting module, and configured to:
perform said authentication based on said input received from said user.

10. The host system according to claim 9, wherein said multimedia content is selected from a group comprising of an image, an audio, a video, an animation, and combinations thereof.

11. The host system according to claim 9, wherein said user prescribed and random parameters are selected from a group of parameters comprising:
one or more languages, font styles, stroke-width and/or colors of said critical information; or
orientation of said critical information within a range of different angles as prescribed by said user; or
location of said critical information within the said multimedia content; or
transparency and/or inter-character distance of said critical information; or
linguistic and paralinguistic characteristics of the voice which are effected by parameters such as pitch, duration, loudness, timbre and/or other aspects of vocal quality; or
video or animation characteristics including number of frames per second, interlaced or progressive, aspect ratio, color space, bit depth, video quality, stereoscopy, compressor (or codec) and/or similar attributes;
some random or user-specified curved path for embedding the said critical information that may have random origin and/or random scaling; or
a combination of region specific characters, alphanumeric and/or other characters/symbols in said critical information; or
partial/full integration of out of band (OOB) authentication or critical information coded using encoded data; or any combination thereof.

12. The host system according to claim 9, wherein said set of at least one user specified multimedia content and said set of user specified parameters is provided by said user using a device and/or selected from a set of pre-stored options on the said host system.

13. The host system according to claim 9, wherein said critical information embedded in said specified multimedia content stored is tamper-resistant and not machine-readable.

14. The host system according to claim 9, wherein said information associated with said authentication is selected from a group of information comprising:
an information about user, account details, user id, random passcode specified by user, transaction details, debit account details, credit account details, an amount of money or any other asset to be transferred, information about host system, one time password (OTP), or any combination thereof.

15. The host system according to claim 9, wherein said critical information is based on said information associated with said authentication and any other information selected from a group of critical information comprising:
an amount of money or any other asset to be transferred, transaction details, debit account details, credit account details, user id, random passcode specified by user, information about user, information about host system, one time password (OTP), and combinations thereof.

16. The host system according to claim 9, wherein said critical information associated with said authentication is embedded completely or partially in said one or more user specified multimedia content stored.

17. A method for authenticating a user during an authentication involving said user and a host system, the method comprising:
using said host system for,
receiving from said user, a set of at least one user specified multimedia content and a set of user specified parameters;
storing said set of at least one user specified multimedia content and said set consisting of user specified parameters;
receiving from a user system information associated with said authentication from said user;
embedding a critical information based on said information received, using said set of user specified parameters and random parameters, in said one or more user specified multimedia content stored, thereby
modifying one or more user specified multimedia content stored into modified multimedia content;
transforming said modified multimedia content into an authenticating multimedia content;
sending said authenticating multimedia content and related information to said user;
receiving an input from said user, the input indicating verification of said authenticating multimedia content and for proceeding said authentication; and
performing said authentication based on said input received from said user.

18. The method according to claim 17, wherein said multimedia content is selected from a group comprising of an image, an audio, a video, an animation, and combinations thereof.

19. The method according to claim 17, wherein said user prescribed and random parameters are selected from a group of parameters comprising:
one or more languages, font styles, stroke-width and/or colors of said critical information; or
orientation of said critical information within a range of different angles as prescribed by said user; or
location of said critical information within the said multimedia content; or
transparency and/or inter-character distance of said critical information; or
linguistic and paralinguistic characteristics of the voice which are effected by parameters such as pitch, duration, loudness, timbre and/or other aspects of vocal quality; or
video or animation characteristics including number of frames per second, interlaced or progressive, aspect ratio, color space, bit depth, video quality, stereoscopy, compressor (or codec) and/or similar attributes;
some random or user-specified curved path for embedding the said critical information that may have random origin and/or random scaling; or a combination of region specific characters, alphanumeric and/or other characters/symbols in said critical information; or
partial/full integration of out of band (OOB) authentication or critical information coded using encoded data; or any combination thereof.

20. The method according to claim 17, wherein said set of at least one user specified multimedia content and said set of user specified parameters is provided by said user using a device and/or selected from a set of pre-stored options on the said host system.

21. The method according to claim 17, wherein said critical information embedded in said specified multimedia content stored is tamper-resistant and not machine-readable.

22. The method according to claim 17, wherein said information associated with said authentication is selected from a group of information comprising:
an information about user, account details, user id, random passcode specified by user, transaction details, debit account details, credit account details, an amount of money or any other asset to be transferred, information about host system, one time password (OTP), or any combination thereof.

23. The method according to claim 17, wherein said critical information is based on said information associated with said authentication and any other information selected from a group of critical information comprising:
an amount of money or any other asset to be transferred, transaction details, debit account details, credit account details, user id, random passcode specified by user, information about user, information about host system, one time password (OTP), and combinations thereof.

24. The method according to claim 17, wherein said critical information associated with said authentication is embedded completely or partially in said one or more user specified multimedia content stored.

25. A computer-readable medium that stores instructions executable by at least one processor to perform a method for authenticating a user during an authentication involving said user and a host system comprising:
receiving from said user, a set of at least one user specified multimedia content and a set of user specified parameters;
storing said set of at least one user specified multimedia content and said set consisting of user specified parameters;
receiving from a user system information associated with said authentication from said user;
embedding a critical information based on said information received, using said set of user specified parameters and random parameters, in said one or more user specified multimedia content stored, thereby
modifying one or more user specified multimedia content stored into modified multimedia content;
transforming said modified multimedia content into an authenticating multimedia content;
sending said authenticating multimedia content and related information to said user;
receiving an input from said user, the input indicating verification of said authenticating multimedia content and for proceeding said authentication; and
performing said authentication based on said input received from said user.

26. A computer-readable medium that stores instructions executable by at least one processor to perform a method for authentication, between a user system and a host system, comprising:
receiving from a user, a set of at least one user specified multimedia content and a set of user specified parameters;
storing said set of at least one user specified multimedia content and said set consisting of user specified parameters, using said host system;
receiving from said user system, information associated with said authentication from said user;
embedding using said host system, a critical information based on said information received, using said set of user specified parameters and random parameters, in said one or more user specified multimedia content stored, thereby modifying one or more user specified multimedia content stored into modified multimedia content;
transforming said modified multimedia content into an authenticating multimedia content;
sending from said host system to said user system, said authenticating multimedia content and related information;
presenting to said user, said authenticating multimedia content and related information, wherein said authenticating multimedia content is perceivable by said user;
receiving an input from said user, the input indicating verification of said authenticating multimedia content and for proceeding said authentication; and
performing said authentication, using said host system, based on said input received from said user.
